(19) United States
(12) Patent Application Publication
(10) Pub. No.: US 2015/0223190 A1
(43) Pub. Date: Aug. 6, 2015

(54) NODE AND METHOD FOR DETERMINING A PACKET DATA NETWORK CONNECTION ANCHOR POINT

(71) Applicant: Jan Backman, Karna (SE)

(72) Inventor: Jan Backman, Karna (SE)

(73) Assignee: TELEFONAKTIEBOLAGET L M ERICSSON (PUBL), Stockholm (SE)

(21) Appl. No.: 14/418,671

(22) PCT Filed: Aug. 3, 2012
(86) PCT No.: PCT/EP2012/065205

§ 371 Date: Jan. 30, 2015

(51) Int. Cl. H04W 64/00; H04W 76/02

(52) U.S. Cl. CPC H04W 64/003; H04W 76/02

(57) ABSTRACT

Example embodiments presented herein are directed towards a mobility management node, and corresponding method, for determining a PDN connection anchor point for the selection of a gateway. The mobility management node is configured to receive an attach request from a wireless terminal. Upon receipt, the mobility management node acquires and analyses a mobility history of the wireless terminal. Based on the mobility history, the mobility management node determines a PDN connection anchor point for at least one PDN connection of the attach request. The mobility management node thereafter obtains an IP address for the determined PDN connection anchor point. The mobility management node also sends a create session request to the gateway node at the obtained IP address. Thus, gateway selection is provided by taking a wireless terminal mobility into account.

### TECHNICAL FIELD

Example embodiments presented herein are directed towards a MME, SGSN, or S4-SGSN, and corresponding method, for determining a PDN connection anchor point for gateway selection.

### BACKGROUND

In a typical wireless communications network e.g. such as a cellular system, wireless terminals, also known as mobile stations and/or user equipment units communicate via a Radio Access Network (RAN) to one or more core networks. The wireless terminals can be mobile stations or user equipment units such as mobile telephones also known as “cellular” telephones, and laptops with wireless capability, e.g., mobile termination, and thus can be, for example, portable, pocket, hand-held, computer-comprised, or car-mounted mobile devices which communicate voice and/or data with radio access network.

The radio access network covers a geographical area which is divided into cell areas, with each cell area being served by a base station—

The base station may, e.g. be a Radio Base Station (RBS), which in some networks is also called “NodeB” or “B node” and which in this document also is referred to as a base station.

A cell is a geographical area where radio coverage is provided by the radio base station equipment at a base station site. Each cell is identified by an identity within the local radio area, which is broadcast in the cell. The base stations communicate over the air interface operating on radio frequencies with the wireless terminal units within range of the base stations.

In some versions of the radio access network, several base stations are typically connected, e.g., by landlines or microwave, to a Radio Network Controller (RNC). The radio network controller, also sometimes termed a Base Station Controller (BSC), supervises and coordinates various activities of the plural base stations connected thereto. The radio network controllers are typically connected to one or more core networks of the wireless communication system.

The Universal Mobile Telecommunications System (UMTS) is a third generation mobile communication system, which evolved from the Global System for Mobile Communications (GSM), and is intended to provide improved mobile communication services based on Wideband Code Division Multiple Access (WCDMA) access technology. UMTS Terrestrial Radio Access Network (UTRAN) is essentially a radio access network using wideband code division multiple access for user equipment units (UEs). The Third Generation Partnership Project (3GPP) has undertaken to evolve further the UTRAN and GSM based radio access network technologies. Long Term Evolution (LTE) together with Evolved Packet Core (EPC) is the newest addition to the 3GPP family.

### SUMMARY

An important function performed in wireless networks is gateway selection. Gateway selection may occur during mobility procedures, for example a handover (e.g., SGW selection), or during an initial attach of a wireless terminal (e.g., PGW or GGSN selection). Currently, gateway selection, namely PGW or GGSN selection, is typically dependent on the Access Point Name (APN) associated with a wireless terminal. A wireless terminal's APN name is generally static, thus gateway selection does not take into account a user's behavior. A need exists for efficient and precise gateway selection.

Thus, according to some of the example embodiments, gateway selection may be provided based on a mobility profile of a wireless terminal. According to some of the example embodiments, a PGW or GGSN selection may be made based on mobility and a SGW selection may be made based on a PGW selection. It should be appreciated that such mobility profile may be provided by a mobility history and/or an expected future mobility trend. Example advantages of the example embodiments may comprise the ability to provide gateway selection based on other credentials besides operator provided identities. Another example advantage of the example embodiments is the reduction of tromboning in the work by reducing the traffic going to particular nodes.

Thus, some of the example embodiments are directed towards a method in a mobility management node for determining a Packet Data Network, PDN, connection anchor point. The mobility management node is configured to be operatively comprised in a wireless communications network. The method comprising: receiving, from a wireless terminal, an attach request message; acquiring and analysing a mobility history of said wireless terminal; determining a PDN connection anchor point for at least one PDN connection of said attach request based on the mobility history; obtaining at least one Internet Protocol, IP, address of the determined PDN connection anchor point; and sending, to at least one gateway node at the at least one obtained IP address, a create session request message, said at least one gateway node being associated with the determined PDN connection anchor point.

Some example embodiments are directed towards a mobility management node for determining a Packet Data Network, PDN, connection anchor point. The mobility management node being configured to be operatively comprised in a wireless communications network, the mobility management node comprising: communications circuitry configured to receive, from a wireless terminal, an attach request message; processing circuitry configured to acquire and analyse a mobility history of said wireless terminal; the processing circuitry further configured to determine a PDN connection anchor point for at least one PDN connection of said attach request based on the mobility history; the processing circuitry further configured to obtain at least one Internet Protocol, IP, address of the determined PDN connection anchor point; and the communications circuitry further configured to send, to at least one gateway node at the at least one obtained IP address, a create session request message, said at least one gateway node being associated with the determined PDN connection anchor point.

### DEFINITIONS

### 3GPP Third Generation Partnership Project

### APN Access Point Name

### BSC Base Station Controller

### DNS Domain Name Server

### E-UTRAN Evolved UTRAN

### EPC Evolved Packet Core

### GERAN GSM Edge Radio Access Network

### GPRS General Packet Radio Service

GSM Global System for Mobile communications

### HLR Home Location Register

### HSS Home Subscriber Server

### IMSI International Mobile Subscriber Identity

### IMEI International Mobile Equipment Identity

### IP Internet Protocol

### LTE Long Term Evolution

### MCC Mobile Country Code

### MME Mobility Management Entity

### MNC Mobile Network Code

### PCRF Policy and Charging Rules Function

### PDN Packet Data Network

### PGW PDN Gateway

### QoS Quality of Service

### RAN Radio Access Network

### RBS Radio Base Station

### RNC Radio Network Controller

### SGSN Serving GPRS Support Node

### SGW Serving Gateway

### UE User Equipment

### UMTS Universal Mobile Telecommunications System

### UTRAN UMTS Terrestrial Radio Access Network

### WCDMA Wideband Code Division Multiple Access

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 is an example illustration of a wireless network;

FIG. 2 is an example node configuration of a MME or SGSN, according to some of the example embodiments; and

FIG. 3 is a flow diagram depicting example operations of the node of FIG. 2, according to some of the example embodiments.

### DETAILED DESCRIPTION

In the following description, for purposes of explanation and not limitation, specific details are set forth, such as particular components, elements, techniques, etc. in order to provide a thorough understanding of the example embodiments. However, it will be apparent to one skilled in the art that the example embodiments may be practiced in other manners that depart from these specific details. In other instances, detailed descriptions of well-known methods and elements are omitted so as not to obscure the description of the example embodiments. The terminology used herein is for the purpose of describing the example embodiments and is not intended to limit the embodiments presented herein.

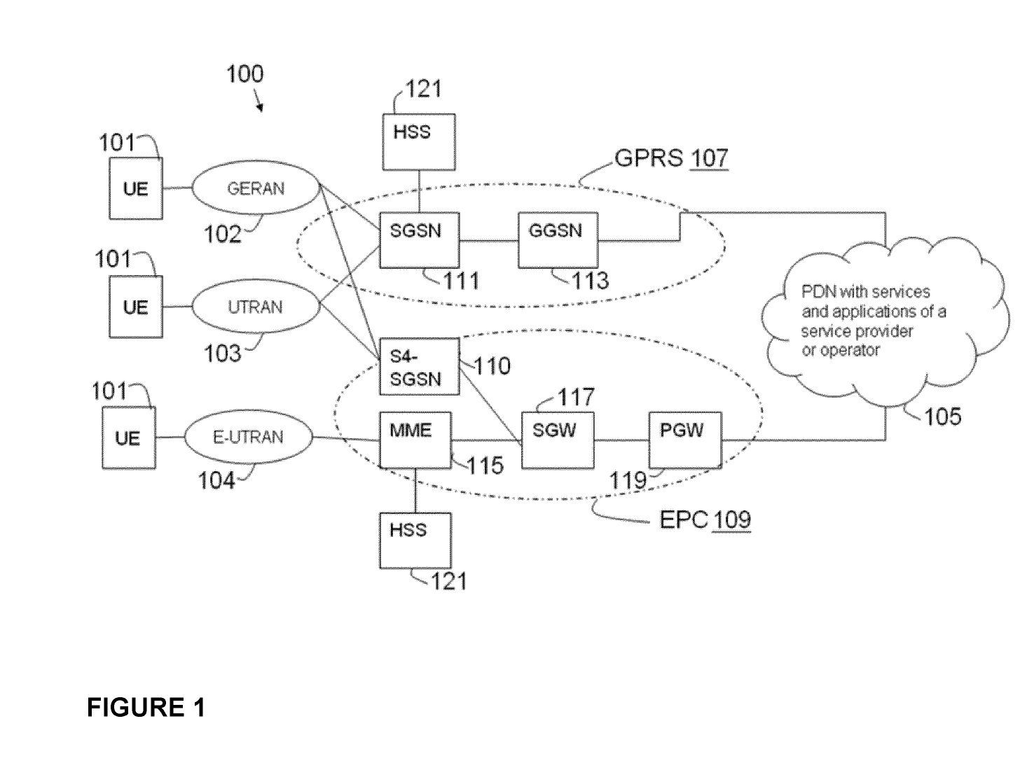

In order to provide a better explanation of the example embodiments presented herein, a problem will first be identified and discussed. FIG. 1 provides an example of a communication network 100. As shown in FIG. 1, a user equipment (UE) 101 may be in communication with a Universal Terrestrial Radio Access Network (UTRAN) 103, an Evolved UTRAN (E-UTRAN) 104, or a GSM Edge Radio Access Network (GERAN) 102 subsystem in order to access communication to an operator or application server 105. In gaining access to the operator or application server 105, the UTRAN/E-UTRAN/GERAN subsystem 102-104 respectively may be in direct or indirect communication with a General Packet Radio Service (GPRS) subsystem 107 or an Evolved Packet Core (EPC) subsystem 109 comprising core network nodes as will be exemplified below. It should also be appreciated that the network may further comprise a WiFi subsystem, although not illustrated in FIG. 1.

The GPRS subsystem 107 may comprise a core network node in the form of a Serving GPRS Support Node (SGSN) 111, which may be responsible for the delivery of data packets to and from the mobile stations within an associated geographical service area. The SGSN 111 may also be responsible for packet routing, transfer, and mobility management with respect to the mobile stations served by the SGSN 111, e.g. when a mobile station moves between the GERAN 102 and the UTRAN 103. The GPRS subsystem 107 may also include a core network node in the form of a Gateway GPRS Support Node 113, which may be responsible for the interworking between the GPRS subsystem 107 and the operator or application server 105.

The EPC subsystem 109 may comprise a core network node in the form of a Mobility Management Entity 115 (MME), which may be responsible for idle mode UE tracking, paging procedures, and attachment and activation processes. The MME 115 may also be responsible for mobility management with respect to the mobile stations served by the MME 115. The EPC subsystem may also comprise a core network node in the form of a Serving Gateway (SGW) 117, which may be responsible for the routing and forwarding for data packets. The EPC subsystem may also include a core network node in the form of a Packet data network Gateway (PGW) 119, which may be responsible for providing connectivity from the user equipment 101 to the operator of application servers 105. Both the SGSN 111 and the MME 115 may be in communication with a Home Subscriber Server (HSS) 121, which may provide device identification information, an International Mobile Subscriber Identity (IMSI), etc. It should be appreciated that the EPC subsystem 109 may also comprise a core network node in the form of a S4-SGSN 110, thereby allowing the GERAN 102 or UTRAN 103 subsystems to be accessed when the GPRS 107 is replaced by the EPC 109. The S4-SGSN 110 may be responsible for mobility management with respect to the mobile stations served by the S3-SGSN 110, e.g. when a mobile station moves between the GERAN 102 or the UTRAN 103 on one hand and the E-UTRAN 104 on the other hand.

An important function performed in wireless networks is gateway selection. Gateway selection may occur during mobility procedures, for example a handover, or during an initial attach of a user equipment. During gateway selection, depending on the type of network being utilized, a gateway node in the form of a SGW and/or PGW and/or a GGSN may be chosen for a particular user equipment. Currently, gateway selection is typically performed using a Domain Name Server (DNS) lookup of a user equipment APN name together with an operator identity (e.g., MCC and/or MNC). It is not possible to provide gateway selections based on credentials other than a user equipment APN name and operator identities. A user equipment's APN name is generally static, thus gateway selection does not take into account a user's behavior but may be performed based on location.

There are numerous disadvantages with the current gateway selection procedures. On example disadvantage is that the user equipment may be assigned to a gateway node which has many other assigned users. However, the user equipment may be in closer proximity to another gateway node or the user equipment may spend a greater deal of time closer to another gateway node, which may not have that many other assigned users. Therefore, basing a gateway node selection on an APN and operator identities may lead to tromboning or an unnecessary use and/or strain on network resources.

Thus, some of the example embodiments presented herein provide a means for gateway selection based on a mobility pattern or history of a user equipment. In some of the example embodiments, the selection of the gateway node may be performed in a mobility management node such as the MME, S4-SGSN, or SGSN, as these nodes are also reasonable for tracking user equipment movement (e.g., through the handling of bearers for the user equipment).

By letting the MME/S4-SGSN/SGSN track and store statistics for the mobility for a device, or user equipment, in the network, it may also look at the mobility history and make educated predictions of the mobility of the device in the future. This will allow for terminate mobility close to the radio interface whenever that is suitable and terminate mobility in a central location whenever that is suitable.

Based on a user equipment mobility, a suitable PDN connection anchor point may be chosen. The PDN connection anchor point is associated with gateway nodes such as the SGW, PGW and/or GGSN mentioned above from which network communications and mobility procedures are conducted through. Whether a gateway node is local, regional or central may e.g. be determined based on the geographical distance between the gateway node and a base station that serves the user equipment. For example, a first distance may indicate a local gateway, and a second longer distance may indicate a regional gateway, and a third longest distance may indicate a central gateway. Alternatively or additionally, whether a gateway node is local, regional or central may e.g. be determined based on the transmission speed (e.g. in terms of roundtrip delay or similar) and/or based on access to a substantially direct transmission channel (e.g. involving no or a few intermediate nodes, e.g. routers or similar). For example, a first high transmission speed and/or a first low number of intermediate nodes may indicate a local gateway, and a second lower transmission speed and/or a second higher number of intermediate nodes may indicate a regional gateway, and a third lowest transmission speed and/or a third highest number of intermediate nodes may indicate a central gateway.

According to some of the example embodiments, once a suitable PDN connection anchor point is determined, a selection of the gateway node may be done by adding a local identifier which may be associated with the PDN connection anchor point (Tracking Area, cell-id, etc.) in front of the APN and MCC/MNC in the DNS lookup. It may also be done by having a local configuration in the MME/S4-SGSN/SGSN for a preferred gateway node for different classes or mobility. It should be appreciated that many IPv6 addresses make IP termination cheaper than before as efficient utilization is not as important as before. The geographic prefixes in IPv6 may also be used to assist in the identification of PDN connection anchor points.

According to some of the example embodiments, a user equipment may be chosen to have a local, regional or central anchor point. It should be appreciated that such anchor point classifications are used merely as examples and any other classification of an anchor point may be utilized. One way of determining whether the device is to be anchored locally (e.g., close to a base station) or centrally in the network is to consider if a device is non-moving or has low mobility (e.g. if the device has been in the same cell/area for a pre-determined period of time). If this criterion has been fulfilled and the device is in idle mode, the device may be triggered by the MME/S4-SGSN/SGSN to reconnect. After the reconnection, the device will be anchored in a local gateway close to the base station or radio interface.

Moving the session, or user equipment, to a central anchor, or gateway, in the network may be performed in a similar way, e.g., by identifying that the user equipment is not anchored in the optimal gateway. Identifying that the gateway is not optimally anchored may be performed, for example, according to policies that may be determined by identifying that the user equipment is connected to a local gateway. Thereafter, when doing a DNS lookup for the anchor-point for the session another local gateway may be selected.

According to some of the example embodiments, the selection of a gateway may be performed in a dynamic fashion. For example, if a device which has previously been anchored locally undergoes increased mobility, another gateway selection may be performed. According to some of the example embodiments, the gateway reassignment may be performed once the user equipment is in idle mode. This way the impact on existing (idle) sessions would be minimized. However, it should be appreciated that the user equipment may be requested by the MME/S4-SGSN/SGSN to initiate an attach procedure at any other time. The request may e.g. be sent directly to the user equipment (e.g. addressed to the user equipment) or it may e.g. be sent to one or more intermediate node(s), which in turn may forward the request to the user equipment or cause the user equipment to initiate an attach procedure.

According to some of the example embodiments, operators may terminate IP connectivity in gateways close to the base station in dense areas, while having larger distances between the device and base station in less populated areas. However, it should be appreciated that people may be travelling with their devices between these areas, especially in the morning and evening. To allow for a more efficient infrastructure, according to some of the example embodiments, such nomadic behaviors may be taken into consideration during the selection of a suitable gateway. Thus, different gateway selections may be provided for different times of the day or of the year.

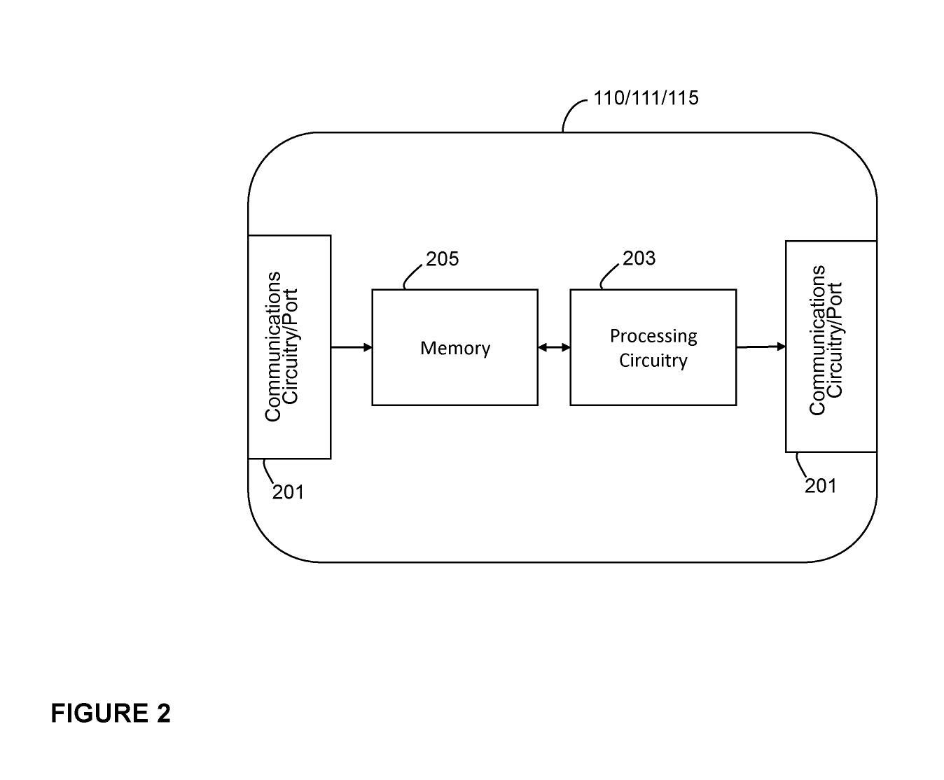

FIG. 2 illustrates an example node configuration of a MME 115, S4-SGSN 110 or a SGSN 111 which may perform some of the example embodiments described herein. The MME/S4-SGSN/SGSN 115, 110, 111 may comprise communications circuitry or a communication port 201 that may be configured to receive and/or transmit communication data, instructions, and/or messages. It should be appreciated that the communications circuitry or communication port 201 may be comprised as any number of transceiving, receiving, and/or transmitting units or circuitry. It should further be appreciated that the communications circuitry or communication 201 may be in the form of any input/output communications port known in the art. The communications circuitry or communication 201 may comprise RF circuitry and baseband processing circuitry (not shown).

The MME/SGSN 115, 110, 111 may also comprise a processing unit or circuitry 203 which may be configured to obtain user equipment mobility history and preferably analyse the user equipment mobility history and determine a PDN connection anchor point. The processing circuitry 203 may be any suitable type of computation unit, e.g. a microprocessor, digital signal processor (DSP), field programmable gate array (FPGA), or application specific integrated circuit (ASIC), or any other form of circuitry. The MME/S4-SGSN/SGSN 115, 110, 111 may further comprise a memory unit or circuitry 205 which may be any suitable type of computer readable memory and may be of volatile and/or non-volatile type. The memory 205 may be configured to store received, transmitted, and/or measured data, device parameters, communication priorities, and/or executable program instructions.

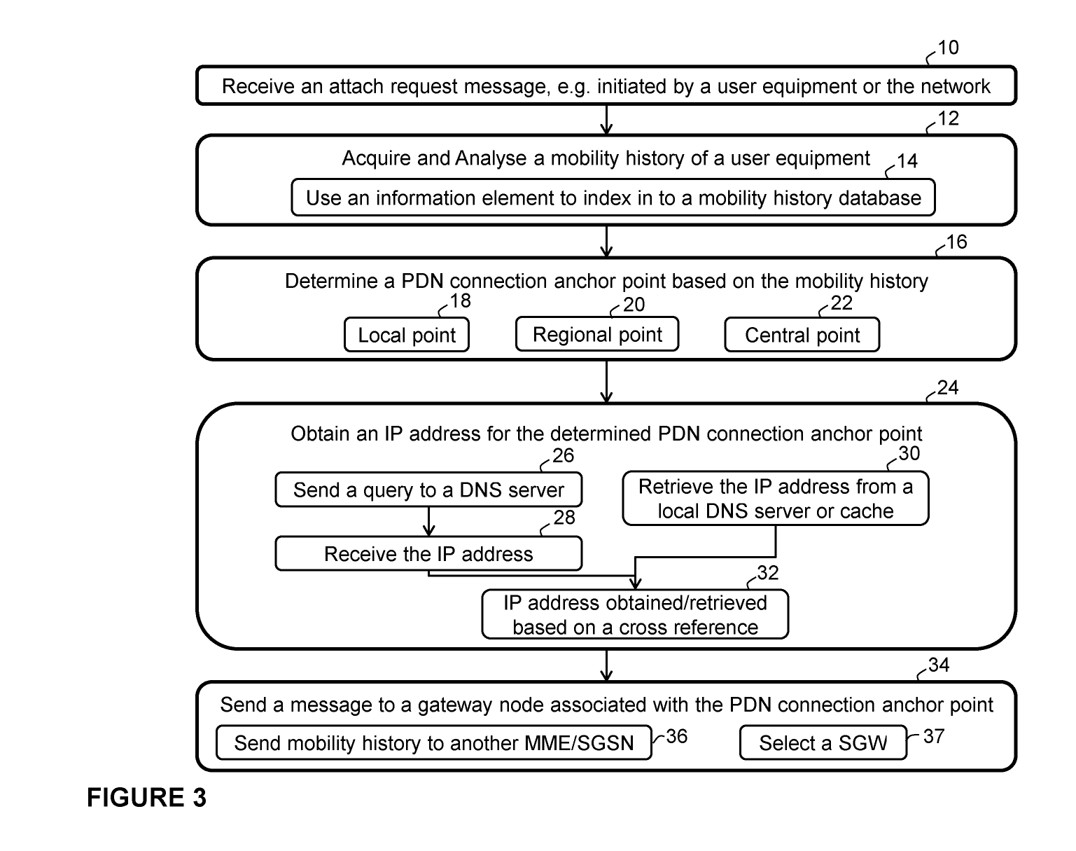

FIG. 3 is a flow diagram depicting example operations which may be taken by the MME/S4-SGSN/SGSN 115, 110, 111 of FIG. 2 for gateway selection. It should also be appreciated that FIG. 3 comprises some operations which are illustrated with a darker border and some operations which are illustrated with a lighter border. The operations which are comprised in a darker border are operations which are comprised in a broad example embodiment. The operations which are comprised in a lighter border are example embodiments which may be comprised in, or a part of, or are further operations which may be taken in addition to the operations of the board example embodiments. It should be appreciated that the operations need not be performed in order. Furthermore, it should be appreciated that not all of the operations need to be performed. The example operations may be performed in any order and in any combination.

According to some of the example embodiments the MME/S4-SGSN/SGSN is an MME or S4-SGSN and the gateway node is a PGW. It should further be appreciated that a SGW may be selected based on the PGW selection. According to some of the example embodiments, the MME/S4-SGSN/SGSN is a SGSN and the gateway node is a GGSN.

Operation 10

The MME/S4-SGSN/SGSN 115, 110, 111 is configured to receive 10, from a user equipment, an attach request message. The communications circuitry 201 is configured to receive, from the user equipment, the attach request message. It should be appreciated that the attach request may be a network or user equipment initiated attach request. For example, in case of a network initiated attach procedure it is preferred that the attach is initiated by the MME/S4-SGSN/SGSN 115, 110, 111, e.g. by sending a message or similar to the user equipment requesting the user equipment to initiate an attach procedure.

Operation 12

The MME/S4-SGSN/SGSN 115, 110, 111 is also configured to acquire user equipment mobility history of the user equipment and preferably analyse 12 the mobility history of the user equipment. The processing circuitry 203 is configured to operatively obtain and analyse the mobility history of the user equipment.

According to some of the example embodiments, the mobility history may comprise information regarding the different locations visited by the user equipment and an amount of time spent in each location. The mobility history may further comprise a user equipment history of signal congestion and/or connectivity errors.

A person skilled in the art having the benefit of this disclosure realises that the mobility history of a user equipment can be acquired by the MME/S4-SGSN/SGSN 115, 110, 111 in many different ways, and the precise manner of acquiring the mobility history is not important for the present solution. For example, information indicative of the mobility history for a user equipment may be acquired from messages or similar handled by the MME/S4-SGSN/SGSN 115, 110, 111, e.g. when taking part in mobility operations for the user equipment. A mobility operation may e.g. involve an attach procedure, a re-attach procedure or a handover procedure or similar of the user equipment. Alternatively or additionally, the MME/S4-SGSN/SGSN 115, 110, 111 may acquire mobility history by requesting information indicative of the mobility history from the user equipment and/or other nodes in the communication network 100. Information indicative of the mobility history may e.g. be stored in the internal memory 205 and/or in an external memory.

Example Operation 14

According to some of the example embodiments, the attach request may comprise an information element providing an identification of the user equipment (e.g., IMEI, IMSI, etc.). Thus, according to some of the example embodiments, the acquiring and analysing 12 may further comprise utilizing 14 the information element as an index into a user equipment mobility history database or table. Such a database or table may be stored within the MME/SGSN (e.g., in memory 205). It should be appreciated that the database or table may also, or alternatively, be located within a HLR, HSS, and/or PCRF node.

Operation 16

The MME/S4-SGSN/SGSN 115, 110, 111 is further configured to determine 16 a PDN connection anchor point for at least one PDN connection, of the attach request, based on the mobility history. The processing circuitry 203 is configured to determine the PDN connection anchor point for at least one PDN connection, of the attach request, based on the mobility history.

Example Operation 18

According to some of the example embodiments, the determining 16 may further comprise determining 18 the PDN connection anchor point as a local point if the user equipment has a level of mobility below a threshold mobility level and/or the user equipment is located near a base station. The processing circuitry 203 may be configured to determine the PDN connection anchor point as a local point if the user equipment has a level of mobility below a threshold mobility level and/or the user equipment is located near a base station.

According to some of the example embodiments, user equipments such as machine-to-machine devices may be categorized as devices with a low level of mobility. Thus, such devices may be determined to have local points. It should be appreciated that a level of mobility may represent how many locations a user equipment has travelled to during a defined period of time. It should also be appreciated that the threshold mobility level may be a dynamic or user programmable threshold which may depend on a user subscription or operator specifications.

Example Operation 20

According to some of the example embodiments, the determining 16 may further comprise determining 20 the PDN connection anchor point as a regional point if the mobility history of the user equipment indicates mobility within a confined area and/or the mobility history comprises an indication of a low signal congestion. The processing circuitry 203 may be configured to determine the PDN connection anchor point as a regional point if the mobility history of the user equipment indicates mobility within a confined area and/or the mobility history comprises an indication of a low signal congestion.

Example Operation 22

According to some of the example embodiments, the determining 16 may further comprises determining 22 the PDN connection anchor point as a central point if the mobility history of the user equipment indicates mobility within a confined area and a number of other users within the confined area is below a user threshold, and/or the mobility history of the user equipment is not repeatable or predictable. The processing circuitry 203 may be configured to determine the PDN connection anchor point as a central point if the mobility history of the user equipment indicates mobility within a confined area and a number of other users within the confined area is below a user threshold, and/or the mobility history of the user equipment is not repeatable or predictable.

Operation 24

The MME/S4-SGSN/SGSN 115, 110, 111 is further configured to obtain 24 at least one IP address of the determined PDN connection anchor point. The processing circuitry 203 is configured to obtain the at least one IP address of the determined PDN connection anchor point.

Example Operation 26

According to some of the example embodiments, the obtaining 24 may further comprises sending 26, to a DNS server, a query for the at least one IP address of the determined PDN anchor point. The communications circuitry 201 may send, to the DNS server, the query for the at least one IP address of the determined anchor point.

According to some of the example embodiments, an identification of the determined PDN connection anchor point may be comprised in the query to the DNS server. Specifically, according to some of the example embodiments, the query may take the form of Anchorarea.APN-name.MNC.MCC.3GPPnetwork.org where the anchor area is the determined PDN connection anchor point. It should be appreciated that the determined PDN connection anchor point need not be a specific point but may also be a location range.

Example Operation 28

According to some of the example embodiments, the obtaining 24 and the sending 26 may further comprise receiving 28, from the DNS server, the at least one IP address of the determined PDN anchor point. The communications circuitry 201 may receive, from the DNS server, the at least one IP address of the determined PDN anchor point.

Example Operation 30

According to some of the example embodiments, the obtaining 24 may further comprise retrieving 30 the at least one IP address from a local DNS server or cache. The processing circuitry 203 may be configured to retrieve the at least one IP address from the local DNS server or cache. According to some of the example embodiments, an identification of the determined PDN connection anchor point may be utilized in retrieving the at least one IP address.

Example Operation 32

According to some of the example embodiments, the obtaining 24, the sending 26, and/or the retrieving 30 may further comprising obtaining or retrieving 32 the at least one IP address based on a cross reference between the identification of the determined PDN connection anchor point and an identification of the gateway node associated with the PDN connection anchor point. The processing circuitry 203 may be configured to obtain or retrieve the at least one IP address based on the cross reference between the identification of the determined PDN connection anchor point and the identification of the gateway node associated with the PDN connection anchor point.

Operation 34

The MME/S4-SGSN/SGSN 115, 110, 111 is further configured to send 34, to one or more gateway node at the at least one obtained IP address, a create session request message. The at least one gateway node is associated with the determined PDN connection anchor point. The communications circuitry 201 is configured to send, to one or more gateway node at the at least one obtained IP address, the create session request message.

According to some of the example embodiments, the create session request may further comprise instructions to provide a differentiated service for any of the services associated with the at least on PDN connection of the attach request. According to some of the example embodiments, the differentiated services may comprise an altered QoS and/or altered charging policies.

Example Operation 36

According to some of the example embodiments, the MME/S4-SGSN/SGSN 115, 110, 111 may be further configured to send 36, to another MME/S4-SGSN/SGSN, a compiled user equipment mobility history during a handover procedure. The communications circuitry 201 may be configured to send, to another MME/S4-SGSN/SGSN, the compiled user equipment mobility history during a handover procedure.

Example Operation 37

According to some of the example embodiments, the MME/S4-SGSN/SGSN is further configured to select a corresponding SGW based on an identification of the at least one gateway node, for example when the MME/S4-SGSN/SGSN is a MME and the at least one gateway node is a PGW. The processing circuitry 203 may be configured to select a corresponding SGW based on the identification of the at least one gateway node.

Some embodiments described above may be summarized in the following manner:

A part of this disclosure is directed to a method in a mobility management node for determining a Packet Data Network, PDN, connection anchor point. The mobility management node is configured to be operatively comprised in a wireless communications network.

The method comprising:
receiving, from a wireless terminal, an attach request message;
acquiring and analysing a mobility history of said wireless terminal;
determining a PDN connection anchor point for at least one PDN connection of said attach request based on the mobility history;
obtaining at least one Internet Protocol, IP, address of the determined PDN connection anchor point; and
sending, to at least one gateway node at the at least one obtained IP address, a create session request message, said at least one gateway node being associated with the determined PDN connection anchor point.

The attach request may comprise an information element providing an identification of the wireless terminal.

The acquiring and analysing may further comprise utilizing the information element as an index into a wireless terminal mobility history database.

The database may be located in at least one of: the mobility management node, or a Home Location Register, HLR, or a Home Subscriber Server, HSS, or a Policy Control and Charging Rules Function, PCRF.

The determining may further comprise determining the PDN connection anchor point as a local point if the wireless terminal fulfils one of or both of:
has a level of mobility below a threshold mobility level or
is located near a base station.

The wireless terminal may be a machine-to-machine device configured for machine-to-machine communications.

The determining may further comprise determining the PDN connection anchor point as a regional point if the mobility history of the wireless terminal indicates one of or both of:
a mobility within a confined area;
a low signal congestion.

The determining may further comprise determining the PDN connection anchor point as a central point if the mobility history of the wireless terminal indicates one of or both of:
a mobility within a confined area and a number of other users within the configured area is below a user threshold;
a mobility of the wireless terminal that is not repeatable or predictable.

The obtaining may further comprise:
sending, to a Domain Name System, DNS, server, a query for the at least one IP address of the determined PDN anchor point; and
receiving, from the DNS server, the at least one IP address of the determined PDN anchor point.

The obtaining may further comprise retrieving the at least one IP address from a local Domain Name System, DNS, server or cache.

The sending or retrieving may be performed using an identification of the determined PDN connection anchor point.

The obtaining may further comprise obtaining the at least one IP address based on a cross reference between the identification of the determined PDN connection anchor point and an identification of the gateway node associated with the determined PDN connection anchor point.

The method may further comprise sending, to another mobility management node, a compiled wireless terminal mobility history during a handover procedure.

The mobility history may further comprise a wireless terminal history of signal congestion and/or connectivity errors.

The create session request may further comprise instructions to provide a differentiated service for any services associated with the at least one PDN connection.

The differentiated service may comprise an altered Quality of Service, QoS, and/or altered charging policies.

The mobility management node may be a Mobility Management Entity, MME and the at least one gateway node may be a PDN Gateway, PGW.

The method may further comprise selecting a corresponding Serving Gateway, SGW, based on an identification of the at least one gateway node.

The mobility management node may be a Serving General Packet Radio Service Support Node, SGSN and the at least one gateway node may be a Gateway General Packet Radio Service Support Node, GGSN.

Some other embodiments described above may be summarized in the following manner:

A part of this disclosure is directed to a mobility management node for determining a Packet Data Network, PDN, connection anchor point, the mobility management node being configured to be operatively comprised in a wireless communications network, the mobility management node comprising:
communications circuitry configured to receive, from a wireless terminal, an attach request message;
processing circuitry configured to acquire and analyse a mobility history of said wireless terminal;
the processing circuitry further configured to determine a PDN connection anchor point for at least one PDN connection of said attach request based on the mobility history;
the processing circuitry further configured to obtain at least one Internet Protocol, IP, address of the determined PDN connection anchor point; and
the communications circuitry further configured to send, to at least one gateway node at the at least one obtained IP address, a create session request message, said at least one gateway node being associated with the determined PDN connection anchor point.

The attach request may comprise an information element providing an identification of the wireless terminal.

The processing circuitry may be further configured to acquire and analyse the mobility history by utilizing the information element as an index into a wireless terminal mobility history database.

The database may be located in at least one of the mobility management node, or a Home Location Register, HLR, or a Home Subscriber Server, HSS, or a Policy Control and Charging Rules Function, PCRF.

The processing circuitry may be further configured to determine the PDN connection anchor point as a local point if the wireless terminal fulfils at least one of:
has a level of mobility below a threshold mobility level or
is located near a base station.

The wireless terminal may be a machine-to-machine device configured for machine-to-machine communications.

The processing circuitry may be further configured to determine the PDN connection anchor point as a regional point if the mobility history of the wireless terminal indicates one or both of:
a mobility within a confined area;
a low signal congestion.

The processing circuitry may be further configured to determine the PDN connection anchor point as a central point if the mobility history of the wireless terminal indicates one or both of:
a mobility within a confined area and a number of other users within the configured area is below a user threshold;
a mobility history of the wireless terminal is not repeatable or predictable.

The processing circuitry may be further configured to obtain the at least one IP address by sending, to a Domain Name System, DNS, server, a query for the at least one IP address of the determined PDN anchor point, and the communications circuitry may be further configured to receive, from the DNS server, the at least one IP address of the determined PDN anchor point.

The processing circuitry may be further configured to obtain the at least one IP address by retrieving the at least one IP address from a local Domain Name System, DNS, server or cache.

The processing circuitry may be further configured to use an identification of the determined PDN connection anchor point in order to obtain the at least one IP address.

The processing circuitry may be further configured to obtain the at least one IP address based on a cross reference between the look-up identification and an identification of the gateway node associated with the PDN connection anchor point.

The communications circuitry may be further configured to send, to another mobility management node, a compiled wireless terminal mobility history during a handover procedure.

The mobility history may further comprise a wireless terminal history of signal congestion and/or connectivity errors.

The create session request may further comprise instructions to provide a differentiated service for any services associated with the at least one PDN connection.

The differentiated service may comprise an altered Quality of Service, QoS, and/or altered charging policies.

The mobility management node may be a Mobility Management Entity, MME and the at least one gateway node may be a Serving Gateway, SGW, and a PDN Gateway, PGW.

The processing circuitry may be further configured to select a corresponding Serving Gateway, SGW, based on an identity of the at least one gateway node.

The mobility management node may be a Serving General Packet Radio Service Support Node, SGSN, SGSN and the at least one gateway node may be a Gateway General Packet Radio Service Support Node, GGSN.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

Also note that terminology such as user equipment should be considered as non-limiting. A device or user equipment as the term is used herein, is to be broadly interpreted to include a radiotelephone having ability for Internet/intranet access, web browser, organizer, calendar, a camera (e.g., video and/or still image camera), a sound recorder (e.g., a microphone), and/or global positioning system (GPS) receiver; a personal communications system (PCS) user equipment that may combine a cellular radiotelephone with data processing; a personal digital assistant (PDA) that can include a radiotelephone or wireless communication system; a laptop; a camera (e.g., video and/or still image camera) having communication ability; and any other computation or communication device capable of transceiving, such as a personal computer, a home entertainment system, a television, etc. It should be appreciated that the term user equipment may also comprise any number of connected devices.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1. A method in a mobility management node for determining a Packet Data Network, PDN, connection anchor point, the mobility management node being configured to be operatively comprised in a wireless communications network, the method comprising:
receiving, from a wireless terminal, an attach request message;
acquiring and analysing a mobility history of said wireless terminal;
determining a PDN connection anchor point for at least one PDN connection of said attach request based on the mobility history;
obtaining at least one Internet Protocol (IP) address of the determined PDN connection anchor point; and
sending, to at least one gateway node at the at least one obtained IP address, a create session request message, said at least one gateway node being associated with the determined PDN connection anchor point.

2. The method of claim 1, wherein the attach request comprises an information element providing an identification of the wireless terminal.

3. The method of claim 2, wherein the acquiring and analysing further comprises utilizing the information element as an index into a wireless terminal mobility history database.

4. The method of claim 3, wherein the database is located in at least one of: the mobility management node, a Home Location Register (HLR), a Home Subscriber Server (HSS), and a Policy Control and Charging Rules Function (PCRF).

5. The method of claim 1, wherein the determining further comprises determining the PDN connection anchor point as a local point if one of or both of the following conditions is met:
the wireless terminal has a level of mobility below a threshold mobility level, and
the wireless terminal is located near a base station.

6. The method of claim 5, wherein the wireless terminal is a machine-to-machine device configured for machine-to-machine communications.

7. The method of claim 1, wherein the determining further comprises determining the PDN connection anchor point as a regional point if the mobility history of the wireless terminal indicates one of or both of:
a mobility within a confined area;
a low signal congestion.

8. The method of claim 1, wherein the determining further comprises determining the PDN connection anchor point as a central point if the mobility history of the wireless terminal indicates one of or both of:
a mobility within a confined area and a number of other users within the configured area is below a user threshold;
a mobility of the wireless terminal that is not repeatable or predictable.

9. The method of claim 1, wherein the obtaining further comprises:
sending, to a Domain Name System, DNS, server, a query for the at least one IP address of the determined PDN anchor point; and
receiving, from the DNS server, the at least one IP address of the determined PDN anchor point.

10. The method of claim 1, wherein the obtaining further comprises retrieving the at least one IP address from a local Domain Name System, DNS, server or cache.

11. The method of claim 9, wherein the sending or retrieving is performed using an identification of the determined PDN connection anchor point.

12. The method of claim 11, wherein the obtaining further comprises obtaining the at least one IP address based on a cross reference between the identification of the determined PDN connection anchor point and an identification of the gateway node associated with the determined PDN connection anchor point.

13. The method of claim 1, further comprising sending, to another mobility management node, a compiled wireless terminal mobility history during a handover procedure.

14. The method of claim 1, wherein the mobility history further comprises a wireless terminal history of signal congestion and/or connectivity errors.

15. The method of claim 1, wherein the create session request further comprises instructions to provide a differentiated service for any services associated with the at least one PDN connection.

16. The method of claim 15, wherein the differentiated service comprises one or more of: an altered Quality of Service (QOS) and altered charging policies.

17. The method of claim 1, wherein the mobility management node is a Mobility Management Entity, MME and the at least one gateway node is a PDN Gateway, PGW.

18. The method of claim 17, further comprising selecting a corresponding Serving Gateway, SGW, based on an identification of the at least one gateway node.

19. The method of claim 1, wherein the mobility management node a Serving General Packet Radio Service Support Node, SGSN and the at least one gateway node is a Gateway General Packet Radio Service Support Node, GGSN.

20. A mobility management node for determining a Packet Data Network (PDN), connection anchor point, the mobility management node being configured to be operatively comprised in a wireless communications network, the mobility management node comprising:
communications circuitry configured to receive, from a wireless terminal, an attach request message;
processing circuitry configured to acquire and analyse a mobility history of said wireless terminal;
the processing circuitry further configured to determine a PDN connection anchor point for at least one PDN connection of said attach request based on the mobility history;
the processing circuitry further configured to obtain at least one Internet Protocol (IP) address of the determined PDN connection anchor point; and
the communications circuitry further configured to send, to at least one gateway node at the at least one obtained IP address, a create session request message, said at least one gateway node being associated with the determined PDN connection anchor point.

21. The mobility management node of claim 20, wherein the attach request comprises an information element providing an identification of the wireless terminal.

22. The mobility management node of claim 21 wherein the processing circuitry is further configured to acquire and analyse the mobility history by utilizing the information element as an index into a wireless terminal mobility history database.

23. The mobility management node of claim 22, wherein the database is located in at least one of the mobility management node, or a Home Location Register, HLR, or a Home Subscriber Server, HSS, or a Policy Control and Charging Rules Function, PCRF.

24. The mobility management node of claim 20, wherein the processing circuitry is further configured to determine the PDN connection anchor point as a local point if the wireless terminal fulfils at least one of:
has a level of mobility below a threshold mobility level or
is located near a base station.

25. The mobility management node of claim 24, wherein the wireless terminal is a machine-to-machine device configured for machine-to-machine communications.

26. The mobility management node of claim 20, wherein the processing circuitry is further configured to determine the PDN connection anchor point as a regional point if the mobility history of the wireless terminal indicates one or both of:
mobility within a confined area;
a low signal congestion.

27. The mobility management node of claim 20, wherein the processing circuitry is further configured to determine the PDN connection anchor point as a central point if the mobility history of the wireless terminal indicates one or both of:
a mobility within a confined area and a number of other users within the configured area is below a user threshold;
a mobility history of the wireless terminal is not repeatable or predictable.

28. The mobility management node of claim 20, wherein the processing circuitry is further configured to obtain the at least one IP address by sending, to a Domain Name System, DNS, server, a query for the at least one IP address of the determined PDN anchor point, and the communications circuitry is further configured to receive, from the DNS server, the at least one IP address of the determined PDN anchor point.

29. The mobility management node of claim 20, wherein the processing circuitry is further configured to obtain the at least one IP address by retrieving the at least one IP address from a local Domain Name System, DNS, server or cache.

30. The mobility management node of claim 28, wherein the processing circuitry is further configured to use an identification of the determined PDN connection anchor point in order to obtain the at least one IP address.

31. The mobility management node of claim 30, wherein the processing circuitry is further configured to obtain the at least one IP address based on a cross reference between the look-up identification and an identification of the gateway node associated with the PDN connection anchor point.

32. The mobility management node of claim 20, wherein the communications circuitry is further configured to send, to another mobility management node, a compiled wireless terminal mobility history during a handover procedure.

33. The mobility management node of claim 20, wherein the mobility history further comprises a wireless terminal history of signal congestion and/or connectivity errors.

34. The mobility management node of claim 20, wherein the create session request further comprises instructions to provide a differentiated service for any services associated with the at least one PDN connection.

35. The mobility management node of claim 34, wherein the differentiated service comprises an altered Quality of Service, QoS, and/or altered charging policies.

36. The mobility management node of claim 20, wherein the mobility management node is a Mobility Management Entity, MME and the at least one gateway node is a Serving Gateway, SGW, and a PDN Gateway, PGW.

37. The mobility management node of claim 20, wherein the mobility management node is a Serving General Packet Radio Service Support Node, SGSN and the at least one gateway node is a Gateway General Packet Radio Service Support Node, GGSN.

38. The mobility management node of claim 36, wherein the processing circuitry is further configured to select a corresponding Serving Gateway (SGW) based on an identity of the at least one gateway node.
